(19) United States
(12) Patent Application Publication
(10) Pub. No.: US 2006/0291452 A1
(43) Pub. Date: Dec. 28, 2006

(54) Method and apparatus for providing reliable communications over an unreliable communications channel

(75) Inventors: Prashant R. Velagaleti, Carpentersville, IL (US); Vernell Chapman, Chicago, IL (US); Guy G. Romano, Elmhurst, IL (US); Vivek V. Thakkar, Elk Grove, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/452,651

(22) Filed: Jun. 14, 2006

Related U.S. Application Data
(60) Provisional application No. 60/693,884, filed on Jun. 24, 2005.

(51) Int. Cl. H04L 12/66

(52) U.S. Cl. 370/352

(57) ABSTRACT

A method and apparatus for providing reliable data communications over an unreliable voice dispatch communications channel is provided. A voice dispatch channel is established between an originating mobile station (102) and a target mobile station (104). The voice communications channel uses a Push-to-view reliability protocol that utilizes real time protocol data packets (500) and real time control protocol control messages (600) to provide the reliable data communications. Data is sent from the originating mobile station to the target mobile station using the RTP data packets. When the target mobile station determines that it is missing data or that the data is corrupted, it sends a negative acknowledge to the originating mobile station using RTCP control messages.

### FIELD OF THE INVENTION

The present invention relates generally to method and apparatus for providing data over a voice communications channel and, more particularly, for providing reliable data communications over an unreliable voice channel such as a voice dispatch channel.

### BACKGROUND

Various forms of wireless communications are known and currently being used throughout the world. Cellular technology provides a large proportion of wireless communications through technologies such as code division multiple access (CDMA), time division multiple access (TDMA), Global System for Mobile Communications (GSM), Universal Mobile Telecommunication System (UMTS) and other standard cellular protocols. Push-to-Talk (PTT) technology, which is a form of dispatch voice communications, is known and commonly used for voice communications. PTT technology is used as a part of the Integrated-Dispatch Enhanced Network (iDEN) communications systems sold and provided by Motorola, Inc. of Schaumburg, Ill. Dispatch voice communications together with cellular communications has been developed. This combination of technologies is known as Push-to-Talk over Cellular (PoC) communication systems.

At the same time that PoC is being developed and before that time, data communications over wireless communication channels has increased. The convergence of these technologies has seen the desire to provide data communications over a PoC wireless communication channel. As such, there is a need for mix-mode transfers of both reliable, e.g. data communications, and unreliable content, e.g. voice communications, either concurrently or consecutively over the same channels including the dispatch channel. As is understood, the convergence of networks and network services support both data communications and voice communications equally well. In some contexts, the mix-mode transfers can be voice and data while in other contexts the transfers can be different types of data communications, such as text, pictures and video. Currently, PoC systems support methods for transporting unreliable loss tolerant communications between clients but not the reliable data communications.

PoC systems typically support methods only for transporting unreliable loss tolerated vocoded data. The data transport protocols for PoC, as they are currently constructed and used, cannot account for complete integrity for data transmissions over PoC channels, provide reliability end-to-end, respond when data is not received at a destination in the correct order, nor support congestion control for TCP-friendly throughput of voice and data during transfer. In addition, the protocols cannot provide for the issues, such as congestion and flow, related to sending voice and data communications through the same channel. This issue becomes more acute as the amount of voice and data communications are sent concurrently and simultaneously through the same channel and as the amount of voice and data communications fluctuates over time.

Current PoC systems do not have the means by which an application can either concurrently, consecutively or independently transfer an object with full reliability from client-to-client within a given inherently unreliable communication session. As such, there is a need in PoC and similar systems for a TCP-like fair usage protocol that can address a mix-mode communication environment by supporting various types of reliable content sharing concurrent with, consecutive to, or independent of unreliable streaming of media, particularly voice communication data.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example wireless communications system used in accordance with some embodiments of the invention.

FIG. 2 is an example of a server used within the wireless communications system.

FIG. 3 is an example of a mobile station used within the wireless communications system.

FIG. 4 is a flow chart of sessions that are used in accordance with the principles of the present invention.

FIGS. 5A and 5B are a call flow chart of data transfer made in accordance with the principles of the present invention.

FIG. 6 is an illustration of a Real Time Protocol (RTP) data packet adapted in accordance with the principles of the present invention.

FIG. 7 is an illustration of a Real Time Control Protocol (RTCP) control message adapted in accordance with the principles of the present invention.

FIG. 8 is a flow chart for the congestion control negotiation of the present invention.

FIG. 9 is a flow chart for the keep-alive procedure of the present invention.

FIG. 10 is an illustration of a common header.

FIG. 11 is an illustration of message types of the present invention.

FIG. 12 is an illustration of an RTCP information control message.

FIG. 13 is an illustration of the information types for the control messages shown in FIG. 12.

FIG. 14 is an illustration of an RTCP command control message.

FIG. 15 is an illustration of the control message types for the messages shown in FIG. 14.

FIG. 16 is an illustration of the RTCP negative acknowledgement messages of the present invention.

FIG. 17 is an illustration of the negative acknowledgement types shown in FIG. 16.

FIG. 18 is an illustration of the RTP data used in accordance with the principles of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to providing reliable communications over an unreliable communications channel. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of providing reliable communications over an unreliable communications channel described herein. The non-processor circuits may include, but are not limited to, a radio receiver, a radio transmitter, signal drivers, clock circuits, power source circuits, and user input devices. As such, these functions may be interpreted as steps of a method to perform providing the reliable communications over the unreliable communications channel. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

To address the need for a reliable data communications over an unreliable communication channel such as a voice dispatch channel, a communication system is provided that adapts the standard protocols used over the communication channel. It will be understood by those of ordinary skill in the relevant arts that the principles of the present invention apply to any number of communication systems and communication system combinations where voice and data, different types of voice and/or different types of data are being transmitted through the communication system. Moreover, the present invention relates to improving the reliability of the voice and data received at a target device and adapting known protocols to achieve such reliability when the original designs, considerations and usages of the systems and protocols accepted a level of unreliability that may not be acceptable in different scenarios. The present invention is applicable to any number of adaptations, is described in the context of sending data communications, which needs to be sent reliably, over a voice dispatch channel, which can be an unreliable channel. One such context is using the voice channel of a Push-To-Talk over Cellular (PoC) communication system to send data.

The PoC channel is provided between an origination mobile station and a target mobile station through the PoC communication network. The originating mobile station notifies the target station that data will be sent over the PoC communication channel using a Push-To-View (PTV) protocol or other Push-to-X protocols, where x denotes a media format or service other than or in addition to the original or primary communication channel. Upon acceptance of the PTV session, the originating mobile station provides data using the Real Time Protocol (RTP) data packets. When the target mobile station determines that it has not received a data packet or that data packets are out of order or sequence, it notifies the originating mobile station by sending a retransmission request message, such as a negative acknowledgment (NACK), by way of Real Time Control Packets (RTCP). Upon receipt of the NACK, the originating mobile station resends missing data. At the completion of sending novel data, the originating mobile station flushes the system and resends data until the target mobile station indicates that it has received all the information.

In another embodiment of the present invention, the transfer of data over the voice dispatch channel is affected by the concurrent and simultaneous transfer of voice and data communications over the same network. As will be appreciated by one of skill in the art, the bandwidth of the channel is limited. In order to overcome the congestion presented by the amount of data being transferred over the channel and the fluctuations in the proportion of voice to data communications, the present invention uses a customized “TCP-friendly” rate control mechanism that can be based on the throughput rates of the voice and data through the channel. TCP-friendly rate control mechanism is understood to be a protocol operation that should approximate, over the duration of transfer, the bandwidth usage characteristics of TCP if TCP were given the same network conditions as those conditions that are present. The control mechanism provides at least a minimum bandwidth for voice or data communications that has priority over one or more other voice or data communications and therefore modifies the flow of data throughput. With an understanding of the present invention as described below, the control messages using RTCP can be used to control the rate of data being sent from the originating mobile station to the target mobile station.

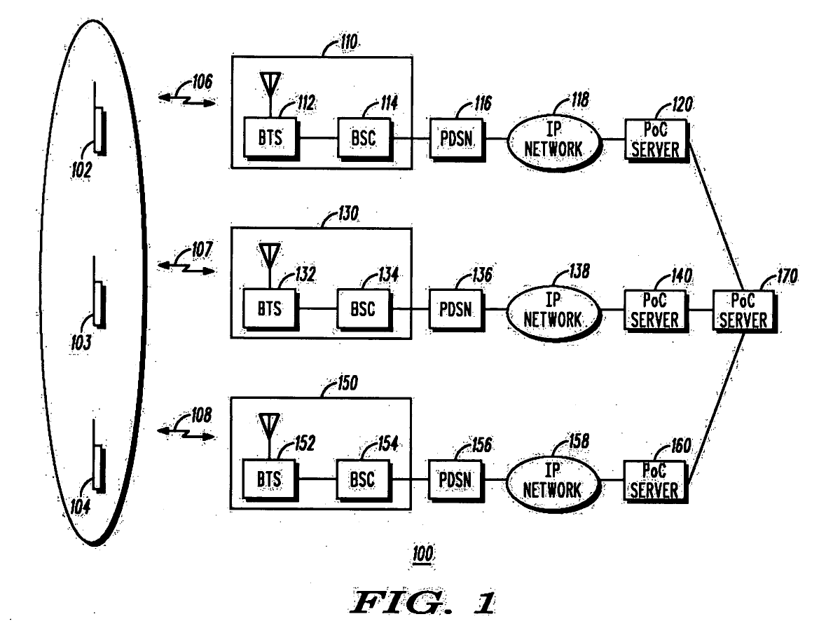

The present invention may be more fully described with reference to FIGS. 1-18. FIG. 1 is a block diagram of a wireless communication system 100 in accordance with an embodiment of the present invention. Communication system 100 includes multiple Base Stations (BSs) 110, 130, 150 (three shown). Each BS of the multiple BSs 110, 130, 150 includes a respective Base Transceiver Station (BTS) 112, 132, 152 that is operably coupled to a respective Base Station Controller (BSC) 114, 134, 154. Each BS 110, 120, 130 is operably coupled to a respective Packet Data Service Node (PDSN) 116, 136, 156, and, via the PDSN and a respective Internet Protocol (IP) core network 118, 138, 158, to a respective Push-to-Talk over cellular (PoC) Server 120, 140, 160. In addition, when one or more of MSs 102-104 is engaged in a PoC communication session, another PoC Server 170 may act as the controlling PoC server for the call. However, in other embodiments of the present invention, the functions performed herein by PoC Server 170 may be performed by a controlling PoC Server function in any one of PoC Servers 120, 140, and 160.

Communication system 100 further comprises multiple PoC-enabled MSs (MSs) 102, 103, 104 (three shown) that are each a member of a talkgroup 105. Each MS 102, 103, 104 is in wireless communication with a respective home network comprising a respective BS 110, 130, 150, a respective PDSN 116, 136, 156, and a respective PoC Server 120, 140, 160. However, those who are of ordinary skill in the art realize that two or more of MSs 102-104 may be serviced by a same BS, PDSN, and/or PoC Server, rather than being serviced by a separate BS, PDSN, and PoC Server, without departing from the spirit and scope of the present invention. Each BS 110, 130, 150 provides communications services to a respective MS 102, 103, 104 via a respective air interface 106, 107, 108 that includes a forward link and a reverse link.

FIG. 2 is a block diagram of a PoC Server 120, 140, 160, 170 in accordance with an embodiment of the present invention. Each PoC Server 120, 140, 160, 170 includes a processor 202, such as one or more microprocessors, microcontrollers, digital signal processors (DSPs), combinations thereof or such other devices known to those having ordinary skill in the art. Each PoC Server 120, 140, 160, 170 further includes at least one memory device 204 associated with processor 202, such as random access memory (RAM), dynamic random access memory (DRAM), and/or read only memory (ROM) or equivalents thereof, that store data and programs, such as group call programs, that may be executed by the processor and that allow the PoC Server to perform all functions necessary to operate in communication system 100.

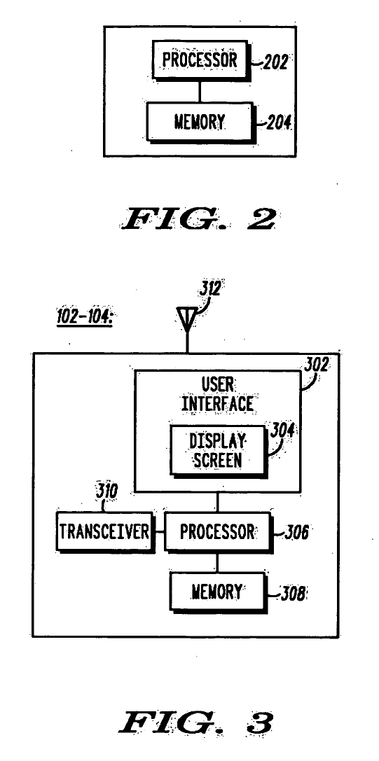

FIG. 3 is a block diagram of a MS (MS), such as MSs 102-104, in accordance with an embodiment of the present invention. Each MS of the multiple MSs 102-104 includes a user interface 302 coupled to a processor 306, such as one or more microprocessors, microcontrollers, digital signal processors (DSPs), combinations thereof or such other devices known to those having ordinary skill in the art. Each MS further includes at least one memory device 308 associated with processor 306, such as random access memory (RAM), dynamic random access memory (DRAM), and/or read only memory (ROM) or equivalents thereof, that maintain data and programs that may be executed by the processor and that allow the MS to perform all functions necessary to operate in communication system 100 including voice and data communications by using transceiver 310 and antenna 312.

User interface 302 provides a user of the MS with the capability of interacting with the MS, including inputting instructions into the MS. In one embodiment of the present invention, user interface 302 may include a display screen 304 and a keypad that includes multiple keys, including a Push-to-Talk (PTT) key and a Push-to-X (PTX) key, which may be used by a user of the MS to input instructions into the MS. In another embodiment of the present invention, display screen 304 may comprise a touch screen that is able to determine a position (i.e., an X-coordinate and a Y-coordinate) of a user's touch on the touch screen and convey the position data to processor 306. Based on the position data, processor 306 then translates the user's touch into an instruction. Preferably, display screen 304 may display a “keypad” screen that comprises multiple softkeys, such as softkeys corresponding to keys on a conventional cellular telephone keypad and further including a PTT or PTX softkey.

The at least one memory device 308 further maintains a mobile ID and a PoC Address that are uniquely associated with the MS. In addition, the at least one memory device 308 further maintains a phone book comprising identifiers associated with MSs and/or talkgroups. The PoC Addresses and talkgroup identifiers may be preprogrammed into the at least one memory device 308 or may be added to the at least one memory device by a user of the MS. When the MS is a member of a talkgroup, such as talkgroup 105, the at least one memory device 308 may further store, in association with the talkgroup identifier, an associated list of PoC Addresses, wherein each PoC Address in the list of PoC Addresses corresponds to an MS that is a member of the talkgroup.

Preferably, communication system 100 is a packet switched CDMA (Code Division Multiple Access) communication system, such as a CDMA 2000 1XEV-DO (1X Evolution Data Only), a CDMA 2000 1XEV-DV (1X Evolution Data and Voice) or a packet switched CDMA 1XRTT (1X Radio Transmission Technology) communication system, that includes PoC capabilities. To ensure compatibility, radio system parameters and call processing procedures are specified by the standards, including call processing steps that are executed by an MS and a base station serving the MS and between the BS and associated infrastructure in order to establish a call or execute a handoff. However, those who are of ordinary skill in the art realize that communication system 100 may operate in accordance with any one of a variety of wireless packet data communication systems capable of providing PoC services, such as but not limited to a General Packet Radio Service (GPRS) communication system, Enhanced Data Rates for GSM Evolution (EDGE) communication system, a Universal Mobile Telecommunication System (UMTS) communication system, a Wireless Local Area Network (WLAN) communication system as described by the IEEE (Institute of Electrical and Electronics Engineers) 802.xx standards, for example, the 802.11, 802.15, 802.16, or 802.20 standards, or Fourth Generation (4G) communication systems such as an Orthogonal Frequency Division Multiple Access (OFDM) communication system.

Using known methods and protocols using BSs 110, 130, 150, servers 120, 140, 160, and other components of system 100, an originating MS 102, which is from among MSs 102-106, establishes a call with the target MS 104, which is from among MSs 102-106 through the communication system 100. As is known for PTT and PoC communications, one originating MS 102 can communicate with more than one target MS 104 and with talkgroups 105. Once a connection is made between the MSs 102, 104, voice communications can be conducted. Data communications can be also be provided over the connection between the MSs. In an alternate arrangement, the target MS 104 can indicate that to the originating MS 102 that multiple devices are associated with the target MS such that on type of communication, e.g. voice, should be sent to one device associated with the target and another type of communication, e.g. data, should be sent to another device associated with the target. For example, a mobile station and a data display can be associated with the target MS such that voice communications are sent to the mobile station and the data communications are sent to the separate data display.

In PoC communication, user datagram protocol (UDP) is used between the MSs 102, 104 and provides a communication layer that is inherently unreliable. As used in this application, unreliable means that all the data that is sent from an originating MS 102 is not necessarily received or is received in a compromised form, such as the data is corrupted during transmission, by the target MS 104. For voice communications, it is not required that the communications connection between MSs be reliable. In other words, in unreliable communications, packet or data loss is acceptable while not being desired.

On the other hand, reliable means that all the data that is sent from an originating MS 102 is received by and verified as being received by the target MS 104. While reliable communications are desired for voice communications and some forms of data communications, other forms of data communications are based on the principle of reliable communications. Without ensuring that data communications are reliable, a file might not include data that is essential for the recreation of the file at the target MS 104 or the file may be corrupted so that the recreation of file is jeopardized. For example, without reliable communications, a PTV transfer would provide a picture that is missing data or corrupted data such that the received picture would be unrecognizable from the picture that was actually transferred. It can be acceptable for reliable data communications that certain data may be missing or corrupted and the data files still are useful, and this can occur in reliable communications when timers expire and the like. But there may be scenarios when all data needs to be received by the target MS and that data cannot be corrupted. In these situations, the connection between the originating and target MS is known as fully reliable.

Push-to-X is a user experience that allows the sharing of discrete files and discrete content over half-duplex and full-duplex communication channels. Push-to-X includes Push-to-View that shares pictures within the context of half-duplex voice communications, such as PoC communications. In order for PTV to operate effectively and efficiently, PTV uses the protocols and procedures of PoC and is therefore also constrained by those protocols and procedures, such as UDP, Real Time Protocol (RTP) and Real Time Control Protocol (RTCP), which are known by those skilled in the art and need not be described in detail here. The present invention relates to the use of RTP and RTCP over UDP to create a reliable and fully reliable data communications over the unreliable voice communications layer provided by UDP. The voice communications channel is divided between a data channel for RTP data packets and a control channel for RTCP control messages. As is known by those skilled in the art, PoC layers RTP and RTCP over UDP to provide voice communications between MSs 102, 104. In PoC, RTP provides a unidirectional path that sends data from the originating MS 102 to the target MS 104 and in the context of the present invention RTP provides data for both voice and data communications. On the other hand, RTCP provides a bidirectional communications path over which control signals are sent between the MSs 102, 104 and so that the target MS 104 can communicate to the server 120, 140, 160, 170 and the originating MS 102.

The present invention relates to a PTX Reliability Protocol (PRP) as a networking mechanism that shuffles discrete data from one client to one or more targets within the framework of the communications channel, such as the PoC voice communications channel, established between MSs 102, 104. PRP uses existing underlying communications protocols such as RTP and RTCP and adds a retransmission request like, for example, a negative acknowledgement (NACK), to be described below, based best-effort and full-reliability mechanism. As voice and data can be sent over the same PoC voice communications channel, the present invention also relates to throughput congestion control that allocates the channel between the voice and data communications based on the parameters of the channel. The principles of PRP, as described herein, generally apply to multiple layers within the OSI stack, including the hybrid layer 5 and transport protocol layer 4. Certain attributes may also extend into the applications layer.

PRP leverages existing protocols such as session initiation protocol (SIP), RTP and RTCP so that data communications can operate over the PoC voice communications channel. SIP is often used for call-setup and capabilities exchange between the MSs 102, 104 and the server 120, 140, 160, 170. RTP is the data bearer, so all discrete file data, both voice and data, is sent over this channel with this protocol. RTCP is the signaling or control pathway for RTP.

In order for the PoC voice communications channel to be reliable, PRP uses a NACK-based system for retransmission requests so the target MS 104 can notify the originating MS 102 or participatory/assisting (e.g. server-assisted transfers) network element that data is missing or out of sequence. Accordingly, when the target MS finds a gap or missing sequence of RTP packets, PRP using RTCP will notify the originating MS or alternate network element, such as servers 120, 140, 160 and 170, of the situation. Originating MS 102 then will respond to the NACK and pause its current progress to retransmit the missing packet(s) or the packets that are out of order. In the context of the present invention, the use of NACKs is efficient for group transmission such as from an originating MS 102 to multiple target MSs 104 that can be within a talkgroup 105. The use of NACKs reduces the amount of signaling overhead within talkgroup situations as well as low-latency, low packet-loss point-to-point communications conditions as compared to ACK mechanisms like TCP. It will be understood by those of skill in the art that other retransmission messages and structures can be used and are included within the scope of the present invention. Nonetheless, NACKs are used when the target device does not receive data and requests that the data be resent.

An internal heuristic is used to determine what the next sequence to transmit should be. The target MS heuristic may determine there is a need to send a retransmission request, or NACK, when one or more conditions or a combination thereof are met. Assuming that a request for resent data has not already been fulfilled, these conditions can include but are not limited to the target MS receiver incoming packet buffer approaching or having been filled; receiver out-of-order buffer approaching or having been filled; expiration of a fixed timer; expiration of a variable timer calculated using congestion control information such as RTT; check if time elapsed since last retransmission request of missing data is greater than a specified threshold; retransmission request is sent on receipt of FLUSH; congestion notification; forward error correction (FEC) is incapable of data recovery; tertiary network element indicates to MS irretrievable loss of information.

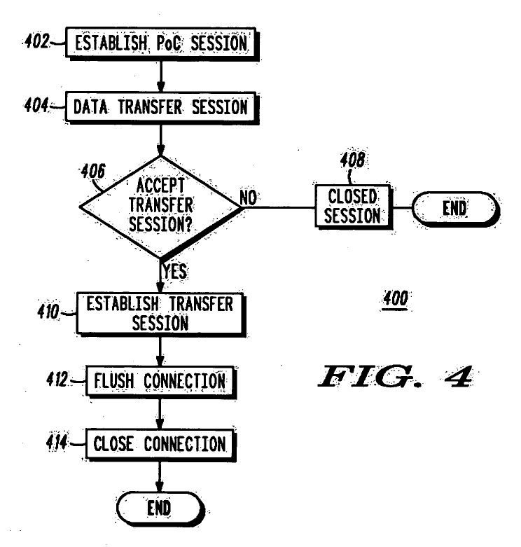

Turning to FIG. 4, an overview of the PRP 400 and its operation is shown. PRP is organized using the notion of transfer sessions. PRP transfer sessions are established 402 before discrete data transfers commence, and in the context of PTV, a picture is taken and then selected as the data to be transferred. In at least one embodiment of the present invention, a PRP session is bounded within a valid floor-control (FC) or talk-burst (TB) possession; FC or TB arbitration is a known part of PoC communications and requires an active or pre-established PoC session. The PoC session itself may be comprised of but not limited to one PoC session with one channel in which one or more media types are interleaved concurrently or consecutively, one PoC session with one or more independent media channels each with their own FC arbitration, one or more PoC sessions each with one channel for one media type, or a combination thereof. It should be understood by those skilled in the art that a given PoC session may be established for sharing of one or more initial communication formats but subsequently updated to allow for one or more additional formats. For example, if a PoC session is activated for the purpose of transferring an image with PRP then the same session may also support voice communication at later time either concurrent or consecutive to the first media format. In another embodiment, a PRP session applies between SIP, or similar agreed upon signaling format, session messages that initiate file transfer and tear downs.

For proper operation, the originating MSs 102 establishes a transfer session 404 where the target MS 104 is in a listening state. This transfer session 404 involves the MS 102 transmitting a PRP RTCP CMD_TRANSFER_REQUEST message to the MS 104. The CMD_TRANSFER_REQUEST message provides many transfer details and metadata about the discrete data to be transferred and is sent using RTCP. These transfer details and metadata include but are not limited to: identifier of media being transmitted such as filename; size of media being transferred; timestamp associated with said media; whether ordering is required for transfer; whether full reliability is required for this transmission; recommended packetization value for said media during transfer; hash and hash type if present; multipurpose internet mail extensions (MIME) top-level and sub-types; queue-depth of sender and receiver; inclusion of congestion notification; FEC parameters and similar enhancements. During this phase, the MS 102 awaits for a reply from the MS 104. When the MS 104 received the request, the MS determines 406 whether to accept or reject MS's 102 request message.

MS 104 conveys its decision to accept or reject the request to MS 102. If the request is rejected 408, the session is terminated via CMD_TRANSFER_CLOSE. If MS 104 accepts the request 410, CMD_TRANSFER_ESTABLISH is sent over RTCP channel and upon receipt the sender will immediately commence file transfer over RTP channel. The CMD_TRANSFER_ESTABLISH command may be re-transmitted after a timeout condition if an appropriate response from the MS 102 is not received. At any point during file transfer, the target MS 104 may transmit a NACK message via RTCP. A NACK requires the originating MS 102 to retransmit the missing data immediately and has precedence over most any other client operations.

When the originating MS 102 has transmitted all novel data packets, it initiates the FLUSH process 412 to acknowledge its own recognition that all the novel data has been transmitted, although not necessarily received by the target MS 104. Upon completion of the FLUSH process, MS 102 responds to any remaining NACK data packets sent by the target 104 so as to conclude the data transfer.

In 414, the termination of the data transfer is completed. Either the originating or target MS 102, 104 can cancel a transfer which results for the exchange of the CMD_TRANSFER_CLOSE command. If and when MS 104 is satisfied all data has been received, it will send the CMD_TRANSFER_CLOSE command. Upon receipt of that command, the originating MS 102 releases FC and the session 400 ends.

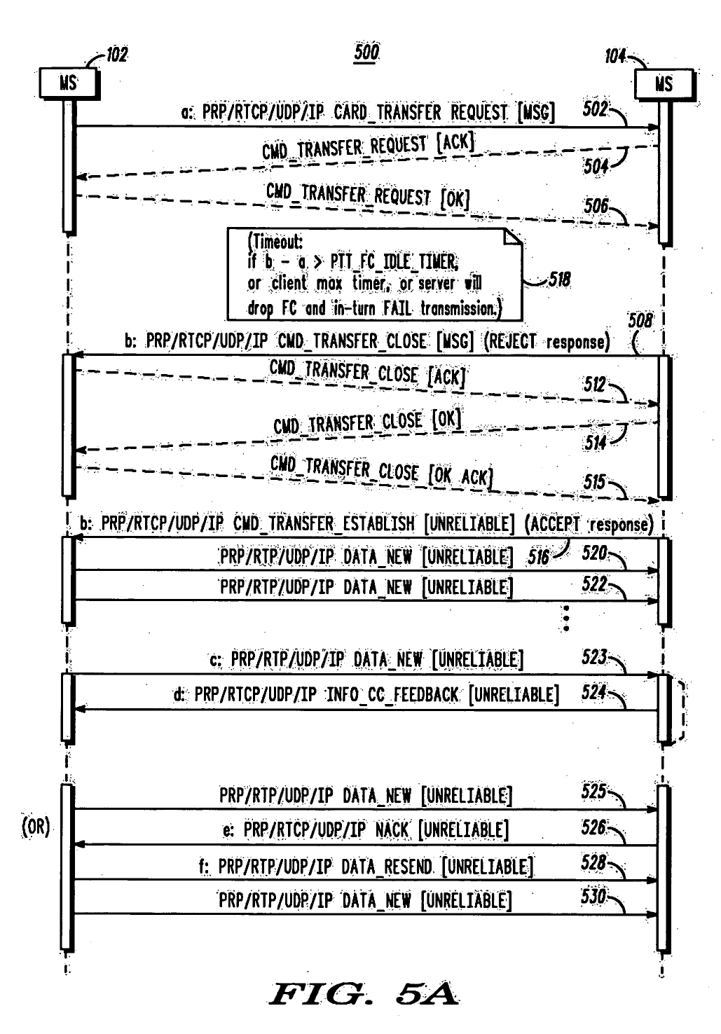

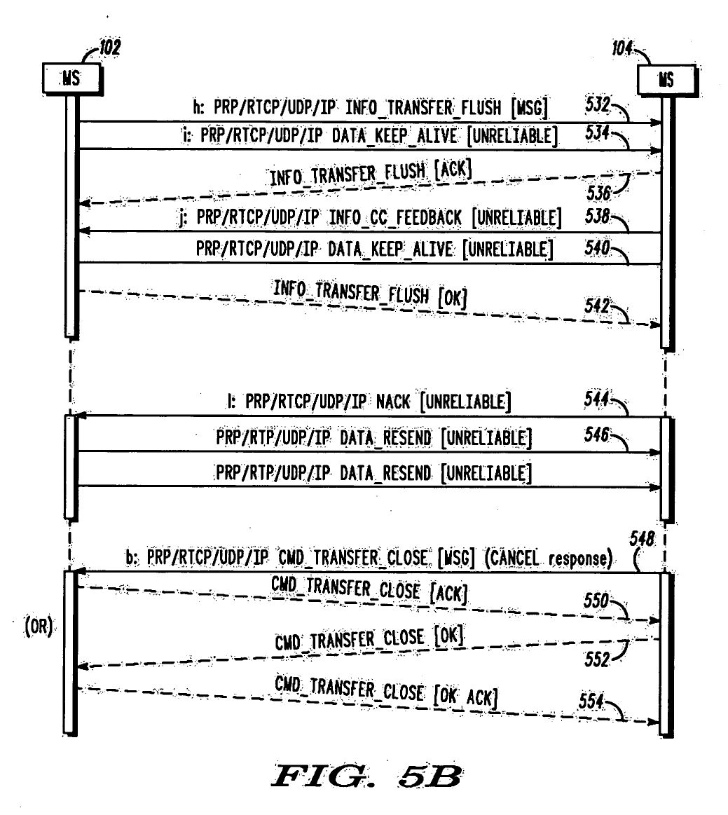

FIGS. 5A and 5B are a call chart 500 of the sessions described for FIG. 2. The originating MS 102 initiates a data transfer session 502 with a CMD_TRANSFER_REQUEST message to the target MS 104. This message is sent as an RTCP control message over the UDP connection established between the MSs 102, 104. As stated above, reliability is one of the objects of the present invention, thus the originating MS 102 should know that the target MS 104 has received the request. A three-way handshake process is used whereby an acknowledgement is therefore sent 504 from MS 104 to MS 102 as an RTCP control message. To increase the reliability of the connection, MS 102 responds to the received acknowledgement with an acknowledgement 506 of its own to MS 104. Both MSs 102, 104 have received acknowledgements so the data connection is established between the two. In an alternate embodiment, one or more transfer requests can be supported simultaneously in one or more PRP transfer sessions. A unique instance message field can be used to differentiate between the respective transfer requests

As mentioned, the target MS 104 may reject the data transfer, and to do so a CMD_TRANSFER_CLOSE message is sent 508 to the originating MS 102 with appropriate failure status. This message is sent as an RTCP control message over the UDP connection established between the MSs 102, 104. A four-way handshake process is conducted between the MSs 102, 104 so that an acknowledgement that the rejection was received is sent 512 from the originating MS 102 to the target MS 104 and an acknowledge that the acknowledgement was received is sent 514 from the target MS 104 to the originating MS 102. Finally, an acknowledgement okay is sent 515 from MS 102 and MS 104 to complete the handshake process.

Instead of rejecting the data transfer, the target MS can also accept the CMD_TRANSFER_REQUEST. To do so, the target MS sends a CMD_TRANSFER_ESTABLISH message 516 to the originating MS 102. This message is sent as an RTCP control message. If the originating MS does not receive either a CMD_TRANSFER_CLOSE message with a failure status or a CMD_TRANSFER_ESTABLISH message after making one or more attempts within a given period of time, a timer, PTT_FC_IDLE_TIMER message, will expire 518, and either the server or the originating MS will terminate the transfer. In an alternate embodiment, the target or originating MS timer may expire. The originating MS or server may also decide this failure constitutes termination of the PRP session thereby releasing associated resources such as FC. The server can be the ultimate arbitrator of the session. Everything can happen with the context of the connection between MSs 102, 104 at the behest of the server.

Once the ESTABLISH message is received, the originating MS can proceed to send data 520 as IP DATA_NEW. This data is sent as RTP data packets from the originating MS 102 to the target MS 104 and itself constitutes an implicit acknowledgement of receipt by of the ESTABLISH to the target MS. MS 102 will continue to send new data 522 until it receives something from MS 104 suggesting otherwise. In one embodiment, target MS can send an IP INFO_CC_FEEDBACK message 524 to the originating MS. This FEEDBACK message is sent as RTCP data as a control message and indicates to the originating MS that the target MS is receiving data.

Data transfer 525 will continue from MS 102 to MS 104 until MS 104 determines that there has been an error in the data transfer. Such an error could be that data is missing or that the data received is not in the correct order, or is otherwise corrupted such that MS 104 cannot use the received data. Upon such an occurrence, target MS 102 (or equivalent assisting network element, e.g. server-assisted transfers) sends a negative acknowledgement, or NACK, message 526 as a retransmission request message to the originating MS 102 to indicate the data transfer error. This message is sent as an RTCP control message over the UDP connection established between the MSs 102, 104. The purpose of the NACK message is for MS 104 to indicate to MS 102 that data has not been properly or incorrectly received at the MS 104. NACK messages can be sent when data is missing, received in an order that is not in sequence, or data is otherwise corrupted. In other words, the NACK message ensures the integrity of the connection and the communications. The NACK message may indicate an actionable request for retransmission in one of several formats or combination thereof including but not limited to: range of packet sequences to resend; bitmap representation of packet sequences to resend and/or those that have been properly received; last consecutive packet sequence received; last known state of queue-depth. Upon receipt of the NACK message, MS 102 resends the missing data 528 to MS 104 in a IP DATA_RESEND message over the UDP channel using RTP data packets. After resending the missing data, MS 102 returns to sending new data 530 until another NACK is received.

New data is sent until MS 102 has no more novel data to send. At this time, an INFO_TRANSFER_FLUSH message is sent 532 from the MS 102 to MS 104 to indicate that MS 102 has completed data transfer. This message is sent over the UDP channel using RTCP control messages. In addition, MS 102 sends a DATA_KEEP_ALIVE message 534 to MS 104 over the UDP channel using an RTP data packet. The KEEP_ALIVE message is sent to maintain floor control as well as assist in continually gauging congestion conditions, until it is confirmed that MS 104 has received all the data. KEEP_ALIVE messages may be continually sent as early as a CMD_TRANSFER_REQUEST and until transfer is complete. MS 104 responds with an INFO_TRANSFER_FLUSH acknowledgement 536 as a RTCP control message in accordance with a three-way handshake with acknowledgement 542. It should be noted that the target MS may subvert processing of the FLUSH message at any time if it is prepared to transmit a CMD_TRANSFER_CLOSE as described below with appropriate status. During this process the target MS 104 can continue to send FEEDBACK messages 538 over RTCP to the originating MS or KEEP_ALIVE messages can be sent 540.

With the receipt of the FLUSH message, the MS 104 will, if necessary, send a NACK message 544, as described above, to indicate that it is missing data. The originating MS 102 will then proceed to resend data 546. The processing of NACK and RESEND messages continues until no more NACK messages are sent and the transfer is closed. When the target MS 104 received all the data so that it is satisfied with the data received from the perspective of reliability and data integrity, it will send to the originating MS 102 a CMD_TRANSFER_CLOSE message 548 with an appropriate status designation over the UDP channel using an RTCP control message. A four-way handshake 550-554 as described above will follow between the MSs 102, 104 to ensure reliability and synchronization of state between the stations that the CMD_TRANSFER_CLOSE message has been received. At this time, the PRP session may be terminated or equivalently FC can be turned over. Alternatively the connection may be maintained if the originating MS has need for additional transfers.

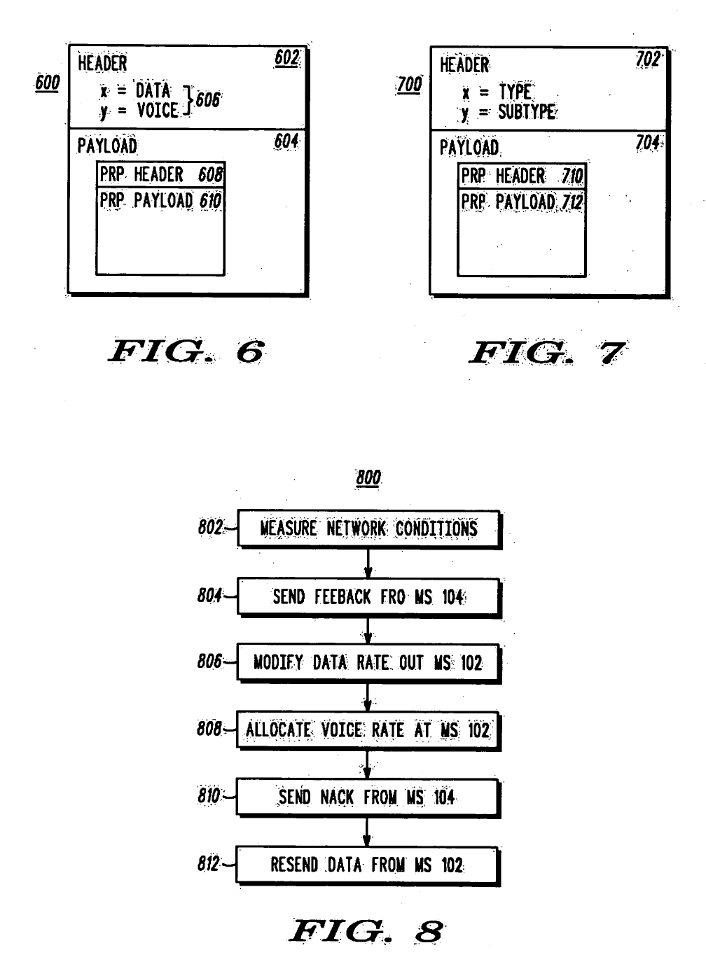

In order for the flow chart of FIGS. 5A and 5B to work properly, it is seen that the MSs 102, 104 exchange both RTP data packets and RTCP control messages over the UDP channel. The PRP of the present invention uses these RTP data packets and RTCP control messages to build a reliable or fully reliable data communications channel over the unreliable UDP voice communications channel. FIGS. 6 and 7 illustrate how the RTP data packets and RTCP control messages are modified and used to increase the reliability of the channel. The present invention focuses on the data packets and control messages because that is a common way of communicating between the MSs. In order to increase reliability of the channel, a bidirectional communications flow is needed and RTCP control messages provide that path.

FIG. 6 shows the RTP data packet 600 of the present invention. Traditionally, the RTP data packet 600 is used to send voice communications over the unreliable UDP channel. At the same time, the present invention uses the RTP data packet 600 to data communications over the unreliable UDP channel. For the present invention, the RTP data packet 600 uses its existing fields so that it could be used for both voice and data communications. The uses of the RTP fields and, as discussed below, the RTCP fields expand their known operations in new and useful ways while operating in the confines of the fields' limits and boundaries.

As is known by those of ordinary skill in the art, the RTP data packet is divided between a header 602 and a payload 604. The header 602 contains different data relevant to the data packet 600. The header information is used by the target device to know information about the data in the payload 604. For the present invention, the header 602 also contains information 606 about the type of data that is contained in the payload. A value of x is used to denote data communications in the payload, and a value of y denotes voice communications in the payload. In at least one embodiment of the present invention, value of 97 is used for voice communications and a value of 125 is used for data communications.

The payload 604 of RTP data packet 600 is the voice communication data or data communication data being sent from the originating MS 102 to the target MS 104. For the present invention, where the RTP data packet is being used for both voice and data communications, the payload 604 for data communications is modified by the PRP. As seen in FIG. 6, the payload 604 includes a header 608 and payload 610. This payload and header content encapsulated in the RTP packet and for the RTCP control messages comprise a PRP IP DATA packet including message parameters, such as congestion control parameters, present in the PRP COMMON HEADER, discussed in more detail below. The PRP IP DATA packet may include but is not limited to: media data packetized to the negotiated value; congestion notification content; FEC content. The payload 610 can include information depending on the contents of the PRP header 608.

Turning to FIG. 7, the RTCP control message 700 of the present invention is shown. Traditionally, the RTCP control message 700 is used in a UDP voice channel to control the voice communications, e.g. FC messages, sender and receiver reports, between the originating and target MSs 102, 104. For the present invention, the RTCP control message 700 is also used to control the data communications, e.g. transfer request retransmission request, cancel, and close messages, between the originating and target MSs 102, 104 and over the same UDP voice channel so as to transform the unreliable voice dispatch channel to a reliable data channel. The RTCP control message 700 includes a header 702 and payload 704. The header 702 is for information relating to the message 700 and the payload 704. For the present invention, the header includes a type 706 and a subtype 708. Type 706 is equal to APP, for an application-defined RTCP packet. Subtype 708 is equal to some negotiated 5 bit value such as per the RTCP specification. Along with a four character RTCP ASCII name field, these standard RTCP fields help to uniquely differentiate a PRP signaling packet from other ancillary communication on the same channel. If desired, PRP signaling over RTCP may be unregulated such that it exceeds defined RTCP compounding, bandwidth and transmission frequency rules so PRP may attain optimal transfer characteristics.

The payload 704 of RTCP control message 700 is the signaling content for the communications being sent from the originating MS 102 to the target MS 104. For the present invention, where the RTCP control message 700 is being used for both voice and data communications, the payload 704 for data communications is modified by the PRP. As seen in FIG. 6, the payload 704 includes a header 708 and payload 710. The PRP common header, header extensions and payload encapsulated in a RTCP packet comprise PRP messages including but not limited to INFO, CMD, and NACK types.

In addition to providing reliable data communications using a NACK based system, the present invention also addresses congestion issues within the voice channel used to transmit the data. These congestion issues can arise when the voice channel is being used when data communications is being sent consecutively to the voice communications or when the voice and data communications are concurrently, or simultaneously, being sent over the channel. As seen in FIG. 8, the present invention uses a customized TCP Friendly Rate Control (TFRC) congestion mechanism 800 that adapts sending data rate to observed network conditions. TFRC permits that TCP throughput rate is maintained in principle and weighting is given to either voice or data communications as needed.

Congestion mechanism 800 begins by measuring 802 network conditions and client status. Such network conditions include data throughput, latencies, packet loss, and data corruption. Client status may include queue-depth, power management, and the like which directly or indirectly impact transfer performance. Typically, these measurements are made at the target MS 104, but can also be made at the originated MS 102 or an alternate network element. Information is sent from MS 104 to MS 102 by way of FEEDBACK messages 804 over the RTCP channel. Upon receipt of the FEEDBACK message, the MS 102 modifies 806 the rate of data transmission.

When attempting concurrent voice and data communications, PRP, through TFRC, may allocate a minimum for the codec vocoding rate (e.g. ˜5 kbps for audio data) 808 from the estimated available bandwidth detected by the congestion control mechanism. The remaining bandwidth, if any, may be used by PRP to reliably transmit the data. This mix-mode observant mechanism is intended to minimize the impact reliable data transfer may have on real-time voice performance. In addition, NACK messages can be sent 810 from MS 104 to MS 102. As is described, the NACK message indicates MS 104 is missing data or the data is corrupted. Upon receipt of the NACK message, MS 102 resends 812 the missing data. The customized PRP congestion control mechanism of TFRC allows participating clients to approximate TCP throughput behavior which is in-turn friendly and fair in its utilization of overall shared network resources. In addition, minimum bandwidth can be used as a minimum threshold that data will transmitted during congestion notification.

PRP provides the server 120, 140, 160, 170 and MSs 102, 104 additional congestion notification (CN) beyond missing packet IDs and loss-event rate, which are sent through FEEDBACK and NACK messages. CN has the property of adjusting the data being sent from MS 102 with MS's 104 need to maintain an efficient ordering of received data due to a finite receive queue. Such notification may include queue-depth of target MS or equivalent network element assisting in transfer. FEC may also be considered by the transfer to accommodate given network conditions. This information may also be temporarily affect MS's 102 sending rate to reconcile sufficiently disparate points of progress among the MSs 102, 104 and server 120, 140, 160, 170. The CN information is in addition to other congestion information shared between the MSs and server as specified by TFRC and PRP.

More particularly, when MS 102 determines that sufficient loss events have occurred, it will send a RTCP control message, a NACK request for retransmission of one or more missing packets identified by sequence_ids in the perceived loss gap events. This NACK transmission may supplant the periodic feedback messages containing other congestion characteristics for the network thereby minimizing the impact of said signaling on the available bandwidth.

As the present invention is relevant to dispatch communications, e.g. PTT and PoC voice communications, floor control (FC) is important. As will be appreciated by those of ordinary skill in the art, a likelihood exists that the transmission of data and the flow of RTP data packets and RTCP control messages may provide gaps that will suggest to the voice channel that the originating MS 102 no longer needs FC. Thus, another device may take control even though the data transmission between MS 102 and MS 104 is not complete.

Transmission behavior, which is a part of CN information, can be amended to include proactive throttling of transmission based on receiver feedback or lack thereof and measured performance of the given network conditions. If the originating MS 102 does not receive a response, such as a FEEDBACK or NACK message, from the target MS 104 that is not reflected in the conditions measured by MS 102, MS 102 can throttle back the flow of data being sent to the MS 104 on its own accord. Such a throttle can be reduced to a flow rate of approximately zero. This will allow the target MS 104 to adjust to the data it has received and send FEEDBACK or NACK messages to receive the needed data. MS 102 throttle control permits the control of data without having to receive specific FEEDBACK or NACK messages.

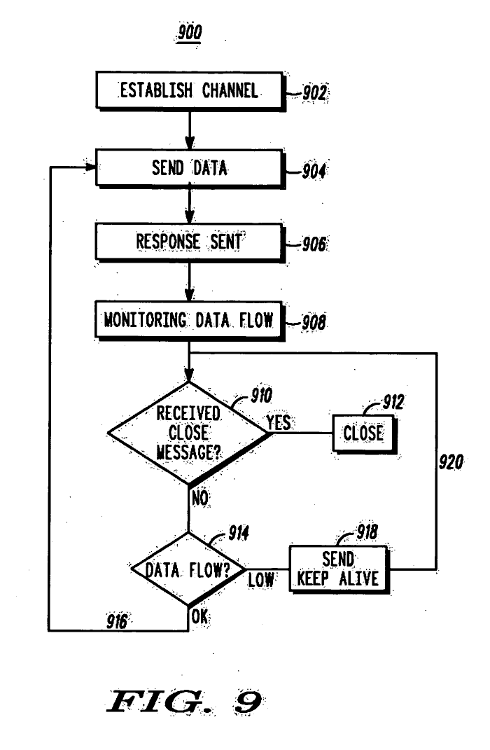

Referring to FIG. 9, a keep-alive process 900 is illustrated. As has been described, the dispatch channel is established 902 and data is sent 904 from MS 102 to MS 104. Responses, such as NACK and FEEDBACK, are sent 906 back to MS 102. As is illustrated in FIG. 8, congestion is monitored 908 including informing the originating MS 102 of the data rate. As data rates decrease from MS 102 to MS 104 but until MS 104 indicates that it has received all the data, the channel needs to be maintained by keeping FC. Thus, the keep-alive process 900 monitors for the close message 910 sent by RTCP. If the CLOSE message is received 912, the channel is closed. If no close message is sent, the data rate is checked 914. If it is acceptable, data is sent 916 from the MS 102. If the rate is too low, to maintain FC, then a KEEP_ALIVE message is sent 918. The process then returns to see if a CLOSE message is sent 920.

Keep-alive RTP data packets may be sent by PRP from the originating MS to the target MS 104 during periods of increased transmission inactivity, such as during data transfer setup and teardown signaling. These keep-alive packets may also be served to indicate a MS's utilization of network resources despite PRP signaling alone. PRP allows the application layer to pause and resume data transmission while periodically transmitting keep-alive packets. In one embodiment, the originating MS 102 will transmit RTP data packets 600 that include a data designation in the header 602. This is considered sufficient as a Keep-alive packet by the protocol.

While the present invention has been described as relating to the communications between an originating MS 102 and a terminating MS 104. Nonetheless, the server 120, 140, 160, 170 can serve as an intermediate party and participate in the exchange of data between a PRP source and destination. The server 120, 140, 160, 170 can interrupt or service transmission requests, either RTP data packets or RTCP control messages. This interjection in signaling may minimize the delay incurred by requests traversing end-to-end/client-to-client as well as mitigating the performance issues that arise from serving a volume of disparate retransmission requests, which can be especially prevalent in group, or multicast, transmissions.

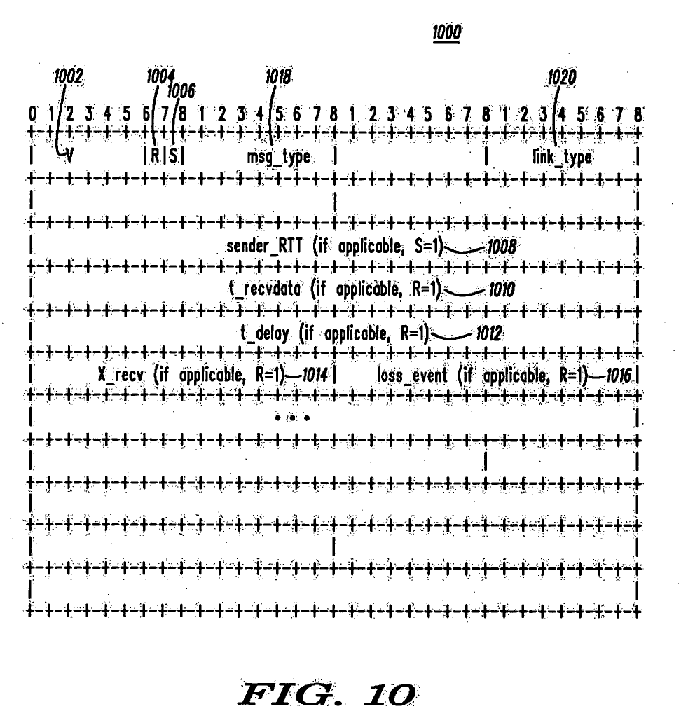

Turning to FIG. 10, a common header 1000 is shown for the PRP data packets that are found in the payloads of the RTP data packet 400 and RTCP control message 500. Known components within header 1000 will not be described in detail while modifications made by the present invention are noted. V bits 1002 are used to indicate the version of the PRP packets that are being sent. The R bit 1004 can be used as a receiver control bit. If this bit is set, it is known that the packet contains content related to the congestion control mechanism according to TFRC. Setting S bit 1006 indicates that the packet contains round-trip time (RTT). The SENDER_RTT 1008 is the field that represents MS's 102 current estimate of RTT. The T_RECVDATA bits 1010 represent the timestamp of the last data packet received by MS 104. These bits 1010 are used by the sender to estimate the round-trip time. The T_DELAY bits 1012 denote the time elapsed between the receipt of the last data packet at MS 104 and the generation of the message. The X_RECV bits 1014 represent the rate at which the receiver estimates that data was received since the last FEEDBACK message was sent. The LOSS_EVENT bits 1016 are the field for the MS 104 current estimate of the last event rate. Bits 1006-1016 are used by the congestion control mechanism. It should be understood that the aforementioned fields are only one way to introduce a TCP-friendly congestion control mechanism and that fields achieving a similar effect are understood to be within the scope of the present invention.

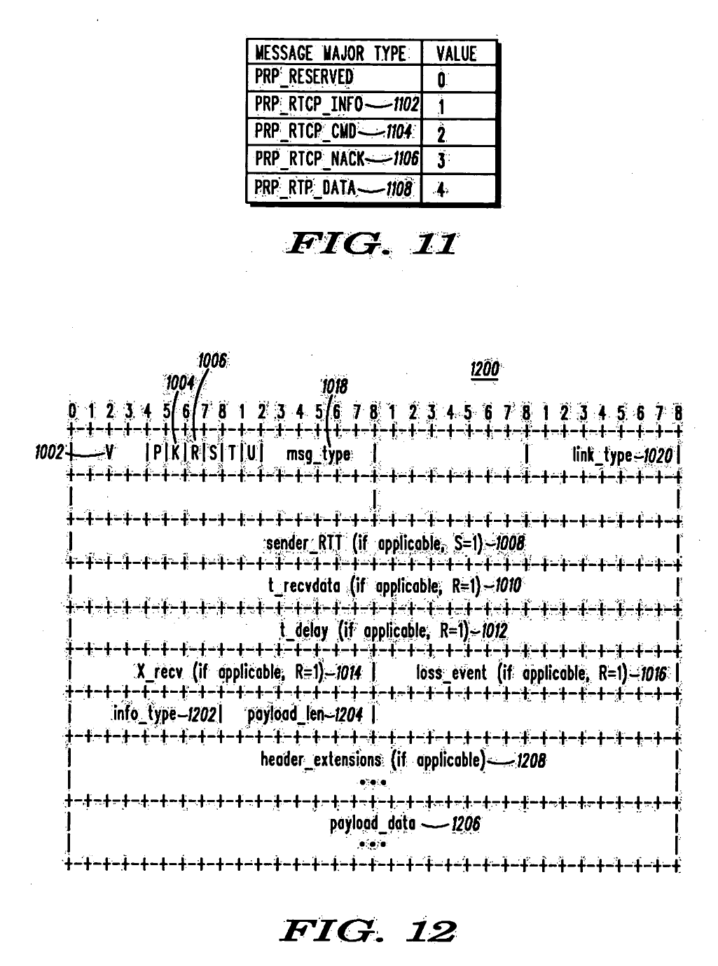

MSG_TYPE bits 1018 is a field used to identify the type of PRP RTP/RTCP message being processed. As an example seen in FIG. 11, the RTCP_INFO 1102, RTCP_CMD 1104, RTCP_NACK 1106 and RTP_DATA 1108 can have values of 0, 1, 2, 3, and 4, respectively. Referring back to FIG. 10, a LINK_TYPE message 1020 defines the reliability of the message. If reliable, the message undergoes an acknowledgement process between the MSs 102, 104. If unreliable, the LINK_TYPE message 1010 will indicate the level of effort the needed to attempt transmission or deliver.

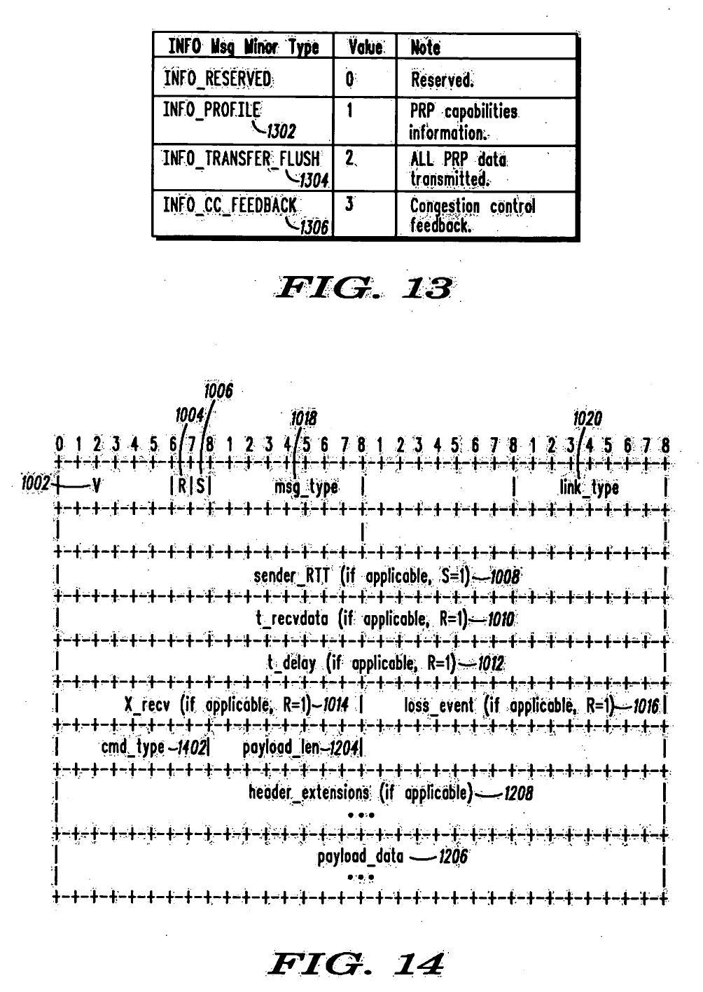

FIG. 12 illustrates the RTCP control message header 1200 for information where the common header 1000 from FIG. 10 is contained within the header 1200. In addition to the common elements described in FIG. 10, header 1200 includes INFO_TYPE portion 1202 that indicates the available messages as seen in FIG. 13. These messages include a PROFILE 1302 for PRP capabilities, TRANSFER_FLUSH 1304, which indicates that all data has been transmitted, and FEEDBACK 1306, which is used by the congestions control mechanism. PAYLOAD_LEN 1204 is the field that indicates the size of the payload 1206. HEADER_EXTENSIONS 1208 are used when additional information is contained within the payload 1206.

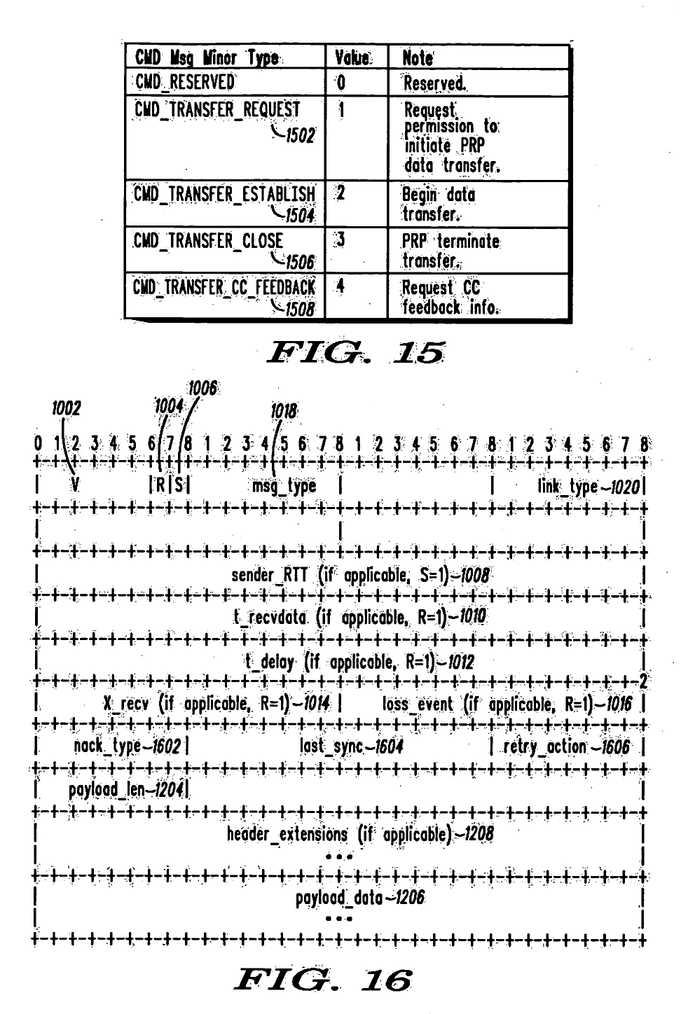

FIG. 14 illustrates the RTCP control message 1400 for commands. CMD_TYPE 1402 indicates one of the available command messages for PRP. These command messages are shown in FIG. 15 and included a REQUEST 1502, ESTABLISH 1504, CLOSE 1506 and FEEDBACK 1508, which have been explained above. Payload for the command is shown in bits 1206. With respect to CLOSE messages 1506, the payload 1206 can include relevant information to be used by the servers 120, 140, 160, 170 such as the size and type of the media transported and MIME information. This information can be used by the servers for billing and other purposes.

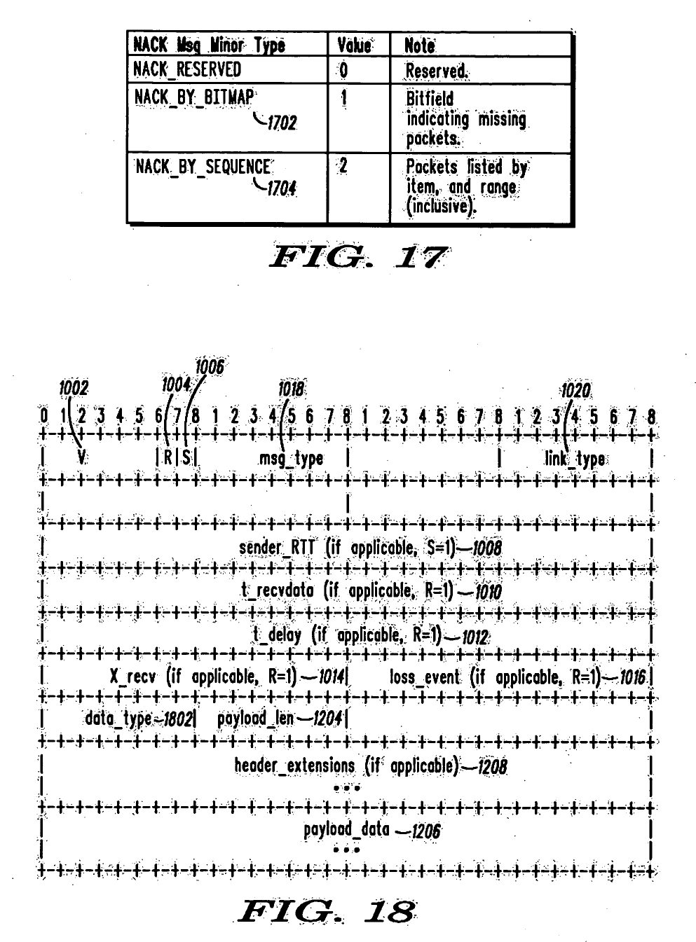

FIG. 16 illustrates the RTCP control message for a NACK 1600. NACK_TYPE bits 1602 indicate the type of NACK being sent in the message. These messages, seen in FIG. 17, include NACK_BY_BITMAP 1702 that states that MS 104 is missing data and NACK_BY_SEQUENCE that lists the item and range of the packets. LAST_SYNC 1604 is the field that holds the unique identifier for the last known good packet of data collected by MS 104. RETRY_ACTION 1606 is a flag that indicates whether the NACK message requires action on the part of MS 104 including a retransmit missing packets message.

The RTP data packet is shown in FIG. 18. DATA_TYPE 1802 is the file that indicates the type of data in the payload 1804. DATA_TYPE 1802 denotes new data, resending data and keep_alive messages.

As discussed, the present invention applies when the data received by the MS 104 is not in the correct order. Nonetheless, the principles discussed herein also apply when the order of data is not essential yet there is still a need fully reliable communications between the originating and target MSs, such as with progressive JPEG.

The respective MS may also derive ancillary transmission parameters from one or more relevant media formats to use in conjunction with its congestion mechanism. This may include but not be limited to a minimum bandwidth value determined from the expected bandwidth requirements of PoC speech. In the case of the Adaptive Multi-Rate (AMR) speech coder a given network must support approximately 5 kilobits per second for proper voice playback and operation. As such PRP may seed its initial transmit rate at start of reliable transfer to be 5 kilobits per second and then subject the transfer to present network conditions. This has the advantage of eliminating an arbitrary slow-start phase by utilizing a relevant assumption of network quality-of-service. PRP may also, in the case of detected congestion, throttle back its transmission rate to no less than this minimum derived from AMR PoC speech.

Moreover, PRP can be configured to keep track of transmission statistics for the average transfer rate and loss rate sustained by a session. These transfer statistics may be correlated alone or combination with but not limited to geographic markers such as a GPS coordinates, cell-id, time-of-day, network capabilities, and even operator network. With this historical information, PRP can better adjust subsequent transfers. In addition the history can be extended to keep track of general level statistics to better inform the PRP protocol and its congestion control mechanism for future transfer operations.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method of providing reliable communications over an unreliable communications channel, the method comprising:
establishing the unreliable communications channel for transmission of data packets and control messages;
providing data over the communications channel between a originating station and a target station;
sending a retransmission request from the target to notify the originating station over the unreliable communications channel when the target station has not received data, and
resending data not received by target station from the originating station to the target station over the communications channel such that the data is reliably sent over the unreliable communications channel.

2. The method according to claim 1 wherein the step of establishing comprising:
establishing a first channel between the originating station and the target station for data packets, and
establishing a second channel between the originating station and the target station for control messages.

3. The method according to claim 1 wherein the step of establishing comprising:
establishing a first channel for unidirectional communications of data packets from the originating station to the target station, and
establishing a second channel for bidirectional communications of control messages between the originating station and the target station.

4. The method according to claim 3 wherein the sending the retransmission request step operates over the second channel and the providing and resending steps operate over the first channel.

5. The method according to claim 3 wherein the first channel utilizes a packet having a header and a payload wherein the packet header designates the payload from among at least two different types of communications and wherein the payload includes a payload header to designate the type of data and payload data.

6. The method according to claim 3 wherein the second channel utilizes a packet having a header and a payload wherein the header designates the type and subtype of control information included in the control packet and the payload includes a control payload header and a control payload data.

7. The method according to claim 3 wherein a command is sent over the second channel to indicate that the originating station has completed sending data over the data channel.

8. The method according to claim 1 wherein the retransmission request is a negative acknowledgement control message.

9. An apparatus for providing reliable communications over an unreliable communications channel, the apparatus comprising:
a processor for processing data received over the unreliable communications channel having a first channel for data packets and a second channel for control messages, and
a transmitter coupled to the processor for transmitting data from the apparatus, wherein the transmitter transmits a retransmission request generated by the processor as a control message over the second channel when the processor detects that the apparatus is missing at least a portion of the communication data needed for reliable communications over the unreliable communications channel.

10. The apparatus according to claim 9 wherein the processor is configured to process data on the first channel and control messages on the second channel.

11. The apparatus according to claim 9 wherein the processor processes a data packet from the communications channel wherein the data packet includes a header to indicate whether the data packet is data or voice and a payload.

12. The apparatus according to claim 9 wherein the processor processes a control message being sent by the transmitter wherein the data packet including a header to indicate the type and subtype of the control message and a payload having a header and a payload.

13. The apparatus according to claim 9 wherein the processor processes a command indicating that communications channel will not be used unless the transmitter sends retransmission request.

14. A method of providing reliable communication over an unreliable communications channel, the method comprising:
establishing the communications channel;
providing at least two types of communication data over the communications channel between a originating station and a target station, and
allocating bandwidth between the at least two types of communication data provided by the communications channel so that the at least two types of communications data can be provided over the channel simultaneously and at least one of the types of communications data is reliably sent to the target station by target station notifying the originating station with a retransmission request that data needs to be resent.

15. The method according to claim 14 wherein the establishing step comprises establishing a first channel for the at least two types of communications data to be received at the target station from the originating station and a control channel for sending control messages between the target station and the originating station and wherein the allocating step utilizes the control channel to allocate the bandwidth of the data channel.

16. The method according to claim 14 wherein the allocating step comprises calculating a transmission rate of the data based on parameters of the communications channel

17. A method of providing reliable communications over an unreliable communications channel, the method comprising:
establishing the unreliable communications channel for transmission of data packets and control messages;
providing data over the communications channel between an originating station and a target station;
sending a retransmission request from one of the target station and a server when the target station has not received data;
resending the data not received by the target station from one of the originating station and the server to the target station over the communications channel such that the data is reliably sent over the unreliable communications channel.

18. The method according to claim 17 wherein the communications channel between the originating station and the target station includes a communications channel between the target station and the server and group communication between the server to a plurality of target stations.

19. The method according to claim 17 wherein the communications channel between the originating station and the target station includes a group communication between the originating station and the server and a group communication between the server and to a plurality of target stations.

20. The method according to claim 17 wherein the communications channel between the originating station and the target station includes a channel between the originating station and the server and a channel between the server and the target station.
